(19) United States
(12) Patent Application Publication
(10) Pub. No.: US 2020/0264895 A1
(43) Pub. Date: Aug. 20, 2020

(54) TECHNIQUES FOR COMPUTING PLATFORM INITIALIZATION

(71) Applicant: INTEL CORPORATION, Santa Clara, CA (US)

(72) Inventors: Xiang MA, Portland, OR (US); Tung Lun LOO, Banyan Lepas, Penang (MY); Yah Wen HO, Butterworth, Penang (MY)

(73) Assignee: INTEL CORPORATION, Santa Clara, CA (US)

(21) Appl. No.: 16/652,020

(22) PCT Filed: Nov. 17, 2017
(86) PCT No.: PCT/US2017/062323

§ 371 Date: Mar. 27, 2020

(51) Int. Cl. G06F 9/4401

(52) U.S. Cl. CPC G06F 9/4405; G06F 9/4411; G06F 9/4406

(57) ABSTRACT

Various embodiments are generally directed to techniques for computing platform initialization, such as by utilizing a field programmable gate array (FPGA) to initialize one or more dependent bootable components (DPCs) of the computing platform, for instance. In one or more embodiments, the FPGA may be reconfigured to perform a runtime operation after initialization of the computing platform. In embodiments described herein, a DPC may include initialization of any hardware or software components of a computing platform, such as silicon components and platform components. In such embodiments, a boot sequence may include boot instructions to initialize a set of DPCs. In some such embodiments, the boot sequence may initialize the computing platform. In one or more embodiments, computing platform initialization may include preparing the computing platform to perform input/output (I/O) operations. In one or more such embodiments, the I/O operations may be performed via an operating system.

### BACKGROUND

When a computing platform initializes, or boots up, it may go through an initial series of processes. The initial series of processes may be referred to as the boot sequence. Typically, during a boot sequence, a computing platform may activate the necessary hardware and software components to enable the computing platform to perform input/output functions. For instance, a boot sequence may conclude when an operating system has been loaded and is ready for user mode. The amount of time a boot sequence takes varies based on the various hardware and software components required by a computing platform.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4 illustrates an embodiment of a first logic flow of offloading portions of platform initialization from a host processor to an FPGA.

FIG. 5 illustrates an embodiment of a second logic flow of distributing computing resources (e.g., drivers) among a host processor and FPGA for computing platform initialization.

FIG. 6 illustrates an embodiment of a third logic flow of executing sets of boot instructions for computing platform initialization.

FIG. 7 illustrates an embodiment of a storage medium.

FIG. 8 illustrates an embodiment of a computing architecture.

FIG. 9 illustrates an embodiment of a communications architecture.

### DETAILED DESCRIPTION

Various embodiments are generally directed to techniques for computing platform initialization, such as by utilizing a field programmable gate array (FPGA) to initialize one or more dependent bootable components (DPCs) of the computing platform, for instance. In one or more embodiments, the FPGA may be reconfigured to perform a runtime operation after initialization of the computing platform. In embodiments described herein, a DPC may include initialization of any hardware or software components of a computing platform, such as silicon components and platform components. In such embodiments, a boot sequence may include execution of one or more sets of boot instructions to initialize a set of DPCs. In some such embodiments, the boot sequence may initialize the computing platform. In one or more embodiments, computing platform initialization may include preparing the computing platform to perform input/output (I/O) operations. In one or more such embodiments, the I/O operations may be performed via an operating system. For instance, the computing platform may perform the I/O operations through an application implemented by the operating system. In embodiments, a computing platform may be referred to as a platform.

Some embodiments described herein are particularly directed to a platform that utilizes both a host processor and an FPGA for platform initialization. In one embodiment, for example, a system for platform initialization may include a platform comprising a set of DBCs, a host processor, and an FPGA. In one or more embodiments, the host processor may execute a first set of boot instructions as part of a boot sequence to initialize the platform to perform I/O operations. In one or more such embodiments, the first set of boot instructions may initialize each DBC in a first subset of the set of DBCs. In various embodiments, the FPGA may execute a second set of boot instructions as part of the boot sequence, the second set of boot instructions to initialize each DBC in a second subset of the set of DBCs. These and other embodiments are described and claimed.

Some challenges facing initialization of platforms includes boot sequences that include boot sequences with computationally intensive boot instructions. The challenges may result from an inability to initialize a required number of DBCs in a boot sequence in an acceptable amount of time. For instance, a host processor may have to execute an entire, or at least an unnecessarily large portion, of the boot instructions in a boot sequence. In some embodiments, this may lead to boot times that exceed boot-time requirements or targets. For instance, computer vision applications may have strict boot-time requirements for safety reasons. In another instance, slow boot times may lead to an unresponsive user interface. Adding further complexity, a boot sequence may include initialization of numerous DBCs with interdependencies. For instance, a first DBC may include a library while a second DBC may include a memory controller that must be loaded before the library can be accessed. This can lead to additional delays in boot time. These and other factors may result in platform initializations with poor performance and limited efficiency. Such limitations can drastically reduce the usability and applicability of the platform, contributing to ineffective systems with limited responsiveness and reduced capabilities.

Various embodiments described herein include a computing platform with an FPGA that can reduce boot time of the platform. In one or more embodiments, multiprocessor firmware flows, as well as the configurability of the FPGA, may be utilized to alleviated constraints on sequentially initializing silicon and platform components. In one or more such embodiments, the constraints may be alleviated with separation of boot flows in a boot sequence to initialize a platform between a host processor and the FPGA. For instance, the host processor may execute a first set of boot instructions as part of the boot sequence and the FPGA may execute a second set of boot instructions as part of the boot sequence. In some embodiments, FPGA can improve boot times to enable the computing platform to meet strict boot time targets. In some such embodiments, a computing platform may have 2 seconds from start until a software application is running. For instance, meeting strict boot time targets may enable the computing platform to be used in autonomous driving applications (e.g., internet of things (IoT) automotive solutions). In some such instances, meeting strict boot time targets may improve the safety of autonomous driving applications. In various embodiments, the FPGA may be reconfigured for one or more runtime operations after the platform has been initialized. In various such embodiments, the one or more runtime operations may enable the computing platform to realize additional and advantageous features. In these and other ways, the computing platform may enable reliable and efficient platform initializations to achieve improved boot times, as well as beneficial and useful runtime features, resulting in several technical effects and advantages.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

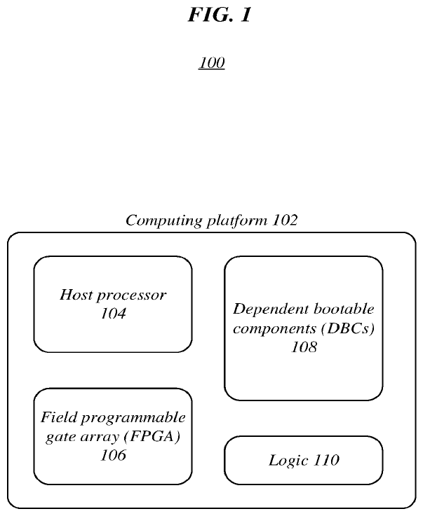

FIG. 1 illustrates an example of an operating environment 100 that may be representative of various embodiments. Operating environment 100 may include computing platform 102 with host processor 104, FPGA 106, a set of DBCs 108, and logic 110. In operating environment 100, host process 104 and FPGA 106 may independently initialize different subsets of the set of DBCs to initialize the computing platform 102 as part of a boot sequence. In various embodiments, the boot sequence may be used to prepare the computing platform to perform I/O operations. For instance, the boot sequence may be used to prepare the computing platform to interact with one or more other computing platforms over a network through an application implemented via an operating system. In some embodiments, logic 110 may initiate a boot sequence to initialize computing platform 102. In one or more embodiments, one or more portions of logic 110 may be implemented to executed by host processor 104 and/or FPGA 106. Embodiments are not limited in this context.

In various embodiments, computing platform 102 may include devices and methods to perform initialization of silicon and platform components (e.g., BDCs 108) using FPGA 106 to shorten a boot sequence of the platform. In many embodiments, multiprocessor firmware flows, such as unified extensible firmware interface (UEFI), CoreBoot, and/or bootloaders, and the configurability of FPGA 106 may reduce limitations associated with sequentially initializing silicon components and/or platform components by means of separation of boot flows between host processor 104 and FPGA 106. In some embodiments, this may be a critical factor in meeting ever-more-stringent boot-time requirements. In various embodiments, FPGA 106 may enable computing platform 102 to have advantageous systems integrations and bill of material (BOM) cost savings when compared to computing platforms without an FPGA capable of accelerating boot operations, as well as provide additional or accelerate existing runtime operations.

In some embodiments, the ability of computing platform 106 to configure and reconfigure FPGA 106 may allow for repurposing of FPGA 106 configuration on the fly and/or per demand For instance, configuring FPGA 106 as a processor engine to assist and speed up platform initialization may occur during a boot phase, while reconfiguring FPGA 106 for a runtime operation, such as deep learning, computer vision, and/or I/O extensions after the boot sequence is complete. In many embodiments, a boot sequence may include one or more of platform initialization and loading of an operating system.

In many embodiments, computing platform 102 may significantly reduce its boot time by utilizing FPGA 106 as a resource for initializing silicon and/or platform components (e.g. DBCs 108) concurrently or even earlier than host processor 104. In some embodiments, host processor 104 may not be able to come out of reset until other dependencies are resolved. For instance, the PMC and converged security engine (CSE) may need to be initialized before a processing core of host processor 104 fetches the first functions (e.g., boot code). Additionally, FPGA 106 may be an independent sub-system that is able to start execution earlier than host processor 104. Accordingly, in such instances, some initializations can be off loaded to FPGA 106. In various embodiments, after host processor 104 is up and running, FPGA 106 may still coordinate with host processor 104, such as to share other workloads to reduce overall system boot time. For example, an embedded multi-media controller (eMMC) and/or universal flash storage (UFS) can take considerable amounts of time for initialization. In such examples, FPGA 106 may start the boot device initialization in advance, and at the time when host processor 104 needs to reads data from a boot media, the FPGA 106 may have previously initialized the boot media.

In various embodiments, repurposing or reconfiguring FPGA 106 at different system phases (e.g., boot phases, runtime phases, user mode, kernel mode, operating system phases, etc.) on demand may realize considerable reductions in overall platform BOM cost as well as runtime platform power consumption. In some embodiments, certain BDCs 108 may only be required during certain system phases. For example, a legacy host SMBus controller may only be required during a memory initialization phase. In such examples, the SMBus controller may read serial presence detect (SPD) information from dual in-line memory modules (DIMMs) and not be used afterwards. In some such examples, FPGA 106 may be configured to provide SMBus controller functionality in an early boot phase. In further such examples, the resources utilized by the FPGA 106 may be reclaimed and programmed into different functionalities required in an OS phase. In some embodiments, FPGA 106 may reduce BOM cost and power consumption by removing legacy SMBus controllers from the design (e.g., system on chip (SoC) design).

One or more embodiments described herein may include a computing platform 102 with logic 110 to perform one or more of the following functions. In some embodiments, the logic 10 may initiate a boot sequence to initialize a platform, such as to perform I/O operations. In various embodiments, the logic 110 may initialize a first subset of the set of DBCs 108 with host processor 104 and a second subset of the set of DBCs 108 with FPGA 106. For example, host processor 104 may execute a first set of boot instructions to initialize each DBC in the first subset of the set of DBCs 108 as part of a boot sequence. In such examples, FPGA 106 may execute a second set of boot instructions to initialize each DBC in the second subset of the set of DBCs 108.

In some embodiments, initialization of a first DBC by host processor 104 may be dependent on initialization of a second DBC by FPGA 106. In this and other embodiments, initialization of a third DBC by FPGA 106 may be dependent on initialization of a fourth DBC by host processor 104. In many embodiments, a first DBC in a first subset of DBCs may include an operating system and a second DBC in a second subset of DBCs may include a firmware interface. In various embodiments, the computing platform 102 may perform I/O operations via an operating system executed by the host processor 104. In some embodiments, a first DBC in the first subset set may comprise a power management controller (PMC) and a second DBC in the second subset may comprise a bus controller, such as a system management bus (SMB) controller.

In many embodiments, a first DBC in the first subset may include a library, and initialization of the first DBC may include loading the library from the memory. In many such embodiments, a second DBC in the second subset may include a memory controller, and initialization of the second DBC may occurs before initialization of the first DBC. In one or more embodiments, a DBC in the first subset of DBCs may comprise a device tree, and initialization of the DBC can include building the device tree. In some embodiments, a DBC in the second subset of DBCs may include a bus design, and initialization of the second DBC includes loading the bus design. In various embodiments, a DBC in the second set of DBCs may comprise a network design, and initialization of the DBC may include loading the network design.

In various embodiments, a DBC in the first subset may comprise a core of the host processor. In some embodiments, a DBC in the first subset may comprise a peripheral component interconnect express (PCIe) device map, and initialization of the DBC may include registering the FPGA 106 as a PCIe endpoint device. In some such embodiments, initialization of the DBC may occur before initialization of a second DBC, which may include PCI enumeration and/or resource allocation. In many embodiments, a DBC in the second subset may include a soft processor of the FPGA 106. In one or more embodiments, the second set of boot instructions may be located in FPGA memory, or memory internal to the FPGA 106. In some embodiments, the FPGA may indicate successful initialization of a DBC in the second subset of DBCs to the host processor 104. In various embodiments, the logic may reconfigure the FPGA to perform a runtime operation after completion of the boot. sequence.

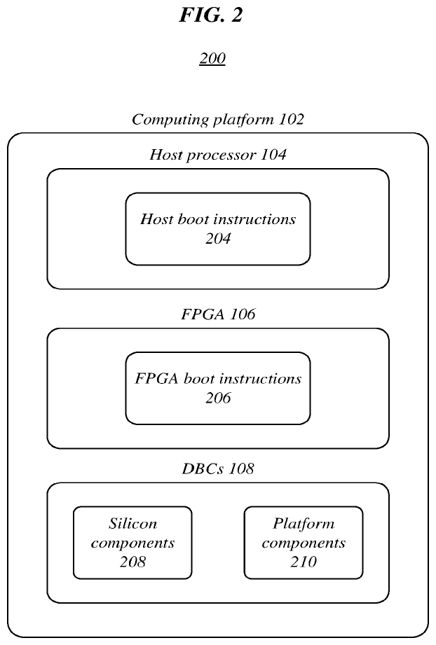

FIG. 2 illustrates an example of an operating environment 200 that may be representative of various embodiments. In addition to the components of operating environment 100, operating environment 200 may include host boot instructions 204, FPGA boot instructions 206, silicon components 208, and platform components 210. In various embodiments, host boot instructions 204 may be stored or loaded to a memory internal to host processor 104 and FPGA boot instructions 206 may be stored or loaded to a memory internal to FPGA 106. In one or more embodiments described herein, host processor 104 may execute host boot instructions 204 and FPGA 106 may execute FPGA boot instructions 206 to initialize silicon components 208 and platform components 210. For example, host processor 104 may initialize a first portion of DBCs 108 and FPGA 106 may initialize a second portion of DBCs 108. Embodiments are not limited in this context.

In one or more embodiments, a boot sequence of computing platform 102 may rely on boot code that may be built and partitioned to be loaded on both the host processor 104 and the FPGA 106. In some embodiments, two separate binaries or sets of binaries may be generated and programmed, one for each of the host processor 104 and FPGA 106 (e.g., host boot instructions 204 and FPGA boot instructions 206). In various embodiments, a host processor binary may be stored in non-volatile serial peripheral interface (SPI) and an FPGA binary may be stored in built-in boot flash.

In some embodiments, on power up, built-in read-only memory (ROM) in the FPGA 106 may initialize a soft processor core. In some such embodiments, the soft processor may then load FPGA boot code from built-in flash to initialize one or more DBCs in set 108, such as silicon or platform components, and then begin execution of the FPGA boot code to initialize a portion of DBCs 108 in computing platform 102. In various embodiments, host processor 104 may also fetch host processor boot code and begins to execute the host processor boot code to initialize another portion of DBCs 108 in computing platform 102. In various such embodiments, host processor 104 may fetch and begin execution of the host processor boot code concurrently with loading and beginning execution of FPGA boot code. In other such embodiments, host processor 104 may fetch and begin execution of the host processor boot code after with loading and beginning execution of FPGA boot code. For instance, host processor 104 may fetch and begin execution of the host processor boot code only once it comes out of reset. In such instances, FPGA 106 may initialize one or more DBCs 108 before host processor 104 comes out of reset.

In various embodiments, at the end of the boot sequence to initialize the computing platform 102 (e.g., after an operating system has been loaded), FPGA 106 may be reconfigured with a different bit stream for runtime operations, such as core applications. For example, core applications may include machine learning, computer vision, deep learning, and similar applications. In one or more embodiments, reconfiguring the FPGA 106 may automatically reclaim previously used FPGA boot sequence resources.

In many embodiments, capabilities of computing platform 102 described herein may be key in enabling other platform design features, such as artificial intelligence, signal processing, and other computational intelligence technologies that may be implemented on or by FPGA 106. Short boot times can be essential in highly responsive computing platforms, and the longer it takes to initialize a platform the longer the readiness of the platform capabilities is hindered. In some embodiments, this may particularly useful in support of self-driving cars, machine vision camera modules, etcetera.

As previously mentioned, host processor 104 and FPGA 106 may each go through individual and separate boot flows (e.g., different initialization processes). In embodiments of FPGA 106 with built-in boot flash capabilities, the device may be initialized and placed into a state pending inputs or instructions from host process 104 almost instantly. In some embodiments, the host processor 104 may have dependencies on other silicon 208 and/or platform components 210, like PMC or security engine readiness, before performing silicon initialization, such as memory I/Os, then followed by platform initialization, such as universal serial bus (USB), ethernet device, graphics) in sequential fashion. In some such embodiments, FPGA 106 may reduce or remove bottle necks resulting from the dependencies to improve boot time of computing platform 102

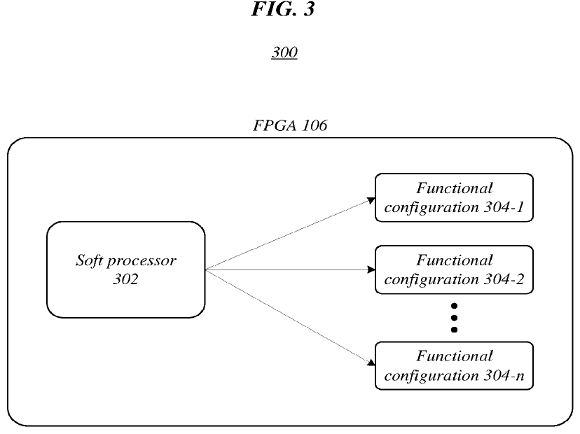

FIG. 3 illustrates an example of an operating environment 300 that may be representative of various embodiments. Operating environment 300 may include FPGA 106 with soft processor 302 and functional configurations 304-1, 304-2, 304-n. In one or more embodiments described herein, FPGA 106 may be reconfigured such that soft processor 304 supports a desired function. In some embodiments, FPGA 106 may be reconfigured by reinitializing soft processor 302 with a desired functional configuration, such as deep learning, machine learning, computer vision, hardware acceleration, etcetera. Embodiments are not limited in this context.

In some embodiments, on power up, built-in read-only memory (ROM) in the FPGA 106 may initialize a soft processor core with an initialization acceleration functional configuration (e.g., functional configuration 304-1). In some such embodiments, the soft processor may then load FPGA boot code from built-in flash to initialize one or more DBCs in set 108, such as silicon or platform components, and then begin execution of the FPGA boot code to initialize a portion of DBCs 108 in computing platform 102. In various embodiments, host processor 104 may also fetch host processor boot code and begins to execute the host processor boot code to initialize another portion of DBCs 108 in computing platform 102. In various such embodiments, host processor 104 may fetch and begin execution of the host processor boot code concurrently with loading and beginning execution of FPGA boot code. In other such embodiments, host processor 104 may fetch and begin execution of the host processor boot code after with loading and beginning execution of FPGA boot code. For instance, host processor 104 may fetch and begin execution of the host processor boot code only once it comes out of reset. In such instances, FPGA 106 may initialize one or more DBCs 108 before host processor 104 comes out of reset.

In various embodiments, at the end of the boot sequence to initialize the computing platform 102 (e.g., after an operating system has been loaded), FPGA 106 may be reconfigured with a different bit stream for runtime operations, such as core applications. In other words, after initialization of computing platform 102, FPGA 106 and/or soft processor 302 can be reconfigured with a desired functional configuration of one or more functional configurations 304-1, 304-2, 304-n. For example, core applications may include functional configurations associated with machine learning, computer vision, deep learning, and similar applications. In one or more embodiments, reconfiguring the FPGA 106 may automatically reclaim previously used FPGA boot sequence resources.

In some embodiments, the ability of computing platform 106 to configure and reconfigure FPGA 106 may allow for repurposing of FPGA 106 configuration on the fly and/or per demand. For instance, configuring FPGA 106 as a processor engine to assist and speed up platform initialization may occur during a boot phase, while reconfiguring FPGA 106 for a runtime operation, such as deep learning, computer vision, and/or I/O extensions after the boot sequence is complete. In many embodiments, a boot sequence may include one or more of platform initialization and loading of an operating system.

In various embodiments, repurposing or reconfiguring FPGA 106 at different system phases (e.g., boot phases, runtime phases, user mode, kernel mode, operating system phases, etc.) on demand may realize considerable reductions in overall platform BOM cost as well as runtime platform power consumption. In some embodiments, certain BDCs 108 may only be required during certain system phases. For example, a legacy host SMBus controller may only be required during a memory initialization phase. In such examples, the SMBus controller may read serial presence detect (SPD) information from dual in-line memory modules (DIMMs) and not be used afterwards. In some such examples, FPGA 106 may be configured to provide SMBus controller functionality in an early boot phase. In further such examples, the resources utilized by the FPGA 106 may be reclaimed and programmed into different functionalities required in an OS phase. In some embodiments, FPGA 106 may reduce BOM cost and power consumption by removing legacy SMBus controllers from the design (e.g., system on chip (SoC) design).

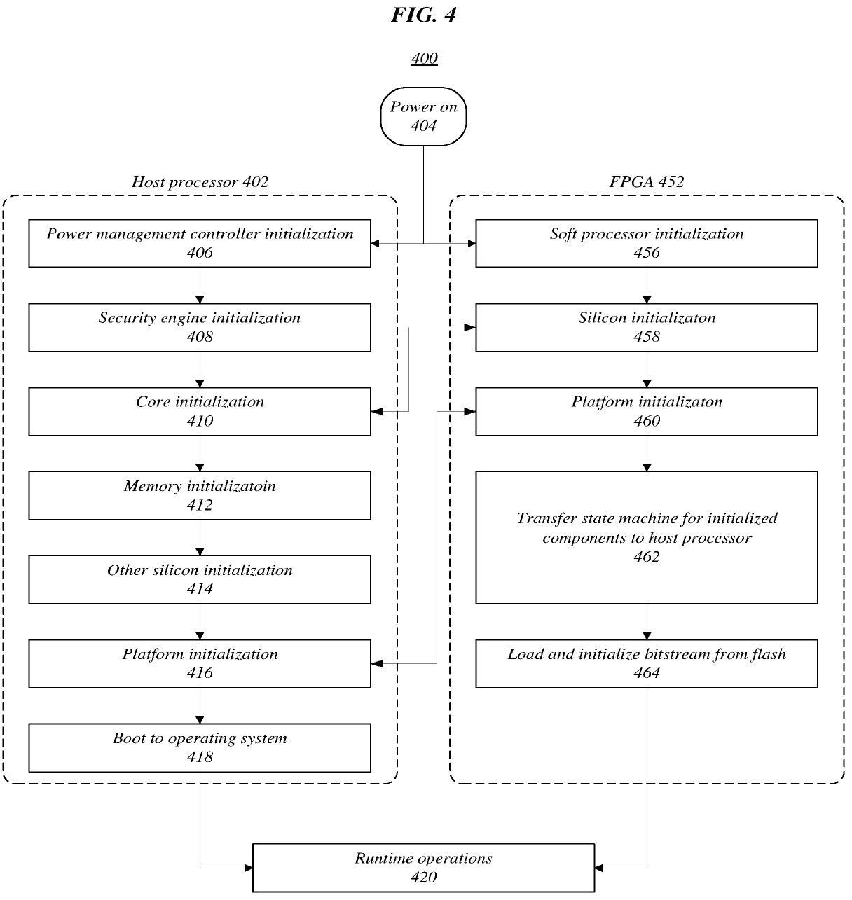

FIG. 4 illustrates one embodiment of a logic flow 400, which may be representative of operations that may be executed in various embodiments in conjunctions with platform initialization. The logic flow 400 may be representative of some or all of the operations that may be executed by one or more components of operating environments 100, 200, or 300 of FIGS. 1-3, such as host processor 104, FPGA 106, and/or logic 110. In one or more embodiments, logic flow 400 may illustrate a portion of the platform initialization being offloaded from a host processor to an FPGA. In one or more such embodiments, the portion of the platform initialization performed by the FPGA may include complete peripherals initialization. In further such embodiments, this may occur concurrently with initialization of the host processor. The embodiments are not limited in this context.

In the illustrated embodiments, it will be appreciated, that steps within the dotted-line box labeled host processor 402 are executed by a host processor, such as host processor 104 and steps within the dotted-line box labeled FPGA 452 are executed by an FPGA, such as FPGA 106. Additionally, one or more steps executed by host processor 402 may be performed through execution of host boot instructions 204 and one or more steps executed by FPGA 452 may be performed through execution of FPGA boot instructions 206.

The logic flow 400 may begin at block 404 “power on”. In various embodiments, in response to computing platform 102 being powered on, host processor 402 may perform power management controller initialization at block 406. Next, at block 408, host processor 402 may perform security engine initialization. Additionally, in response to computing platform 102 being powered on, FPGA 106 may perform soft processor initialization at block 456. Continuing to block 410, host processor 402 may perform core initialization. For instance, host processor 402 may initialize one of its own cores. Referring back to block 456 “soft processor initialization”, after initialization of the soft processor, FPGA may begin silicon initialization at block 458. For instance, one or more silicon components 208 may be initialized. In some embodiments, an indication of initialization success or state may be provided to host processor 402. In various embodiments, performance of core initialization at block 410 may depend on the silicon initialization performed in bock 458.

Continuing to block 412, host processor 402 may perform memory initialization. For example, host processor may initialize a memory controller or memory interface. At block 414, host processor 402 may perform other silicon initialization. For instance, host processor 402 may initialize any of silicon components 208 not already initialized by FPGA 452, such as at block 458. Proceeding to block 416 “platform initialization”, host processor 402 may initialize one or more platform components, such as one or more of platform components 210. Referring back to block 458 “silicon initialization”, after FPGA 452 initializes the silicon components at block 458, it may perform platform initialization 460. In various embodiments, platform initialization at block 416 may initialize a first portion of platform components 210 and platform initialization at block 460 may initialize a second portion of platform components 210.

Proceeding to block 462 “transfer state machine for initialized components to host processor”, FPGA 452 may communicate state machine information for initialized components to host processor 402. In other words, in some embodiments, FPGA 452 may provide an indication of the state of one or more components it initialized to host processor 402. Referring to block 418 “boot to operating system”, host processor 402 may boot to an operating system once all the silicon components 208 and platform components 210 are initialized. Referring not to block 464, FPGA 452 may load and initialize a bitstream from flash, such as to reconfigure itself to perform a runtime operation. At block 420, one or more of host processor 402 and FPGA 452 may perform one or more runtime operations.

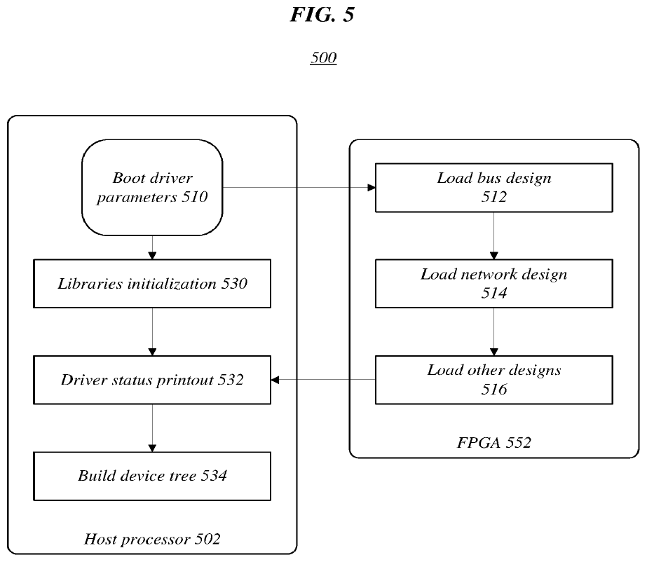

FIG. 5 illustrates one embodiment of a logic flow 500, which may be representative of operations that may be executed in various embodiments in conjunctions with platform initialization. The logic flow 500 may be representative of some or all of the operations that may be executed by one or more components of operating environments 100, 200, or 300 of FIGS. 1-3, such as host processor 104, FPGA 106, BDCs 108, and/or logic 110. In one or more embodiments, logic flow 500 may demonstrate the arbitration of drivers enabled though computing platform 102. The embodiments are not limited in this context.

In the illustrated embodiments, it will be appreciated, that steps within the dotted-line box labeled host processor 502 are executed by a host processor, such as host processor 104 and steps within the dotted-line box labeled FPGA processor 552 are executed by an FPGA, such as FPGA 106. Additionally, one or more steps executed by host processor 502 may be performed through execution of host boot instructions 204 and one or more steps executed by FPGA 552 may be performed through execution of FPGA boot instructions 206.

In some embodiments, computer platform 102 may provide an architecture that offloads silicon component and/or platform component initializations to an FPGA. In some such embodiments, one or more FPGA designs (e.g., functional configurations) may be included and/or stored in the FPGA. In many embodiments, during boot, the host processor 502 and FPGA 552 may share responsibilities of completing silicon and platform component related initializations. In embodiments in which the FPGA includes an internal flash storage, it may be powered on and the soft processor initialized much earlier than host processor 502. In various embodiments, host processor 502 may act as a main controller of a state machine to configure operation of the FPGA, such as loading sequences and parameters of various designs.

The logic flow 500 may begin at block 510 “boot driver parameters”. In some embodiments, the boot driver parameters may be loaded based on the detected computing platform (e.g., DBCs 108, platform identifiers, etc.)”. The FPGA 552 may then be used to load appropriate designs in a defined order, such as driver designs. In such situations, FPGA 552 may be used to perform initializations that include loading of a bus design at block 512, loading of a network design ay block 514, and loading of other designs at block 516. In many embodiments, an error status may be propagated, such as by one or more of host processor 502 and FPGA 552. After block 516, in some embodiments, FPGA 552 may send a boot log, such as one consolidated by FPGA 552 to host processor 502.

Referring back to block 510, in response to loading the boot driver parameters, host processor 502 may perform library initialization 530. At block 532, host processor 502 may generate a driver status printout 532. In one or more embodiments, the driver status printout 502 may be based on a boot log sent to host processor 502 from FPGA 552 after step 516. Proceeding to block 534 “build device tree”, host processor 502 may execute operations to build a device tree. In some embodiments, the device tree may include an advance configuration and power interface (ACPI) tree. In various embodiments, host processor 502 may construct one or more ACPI parameters and a device tree based on output from FPGA 552, such as output provided before passing control to the operating system kernel.

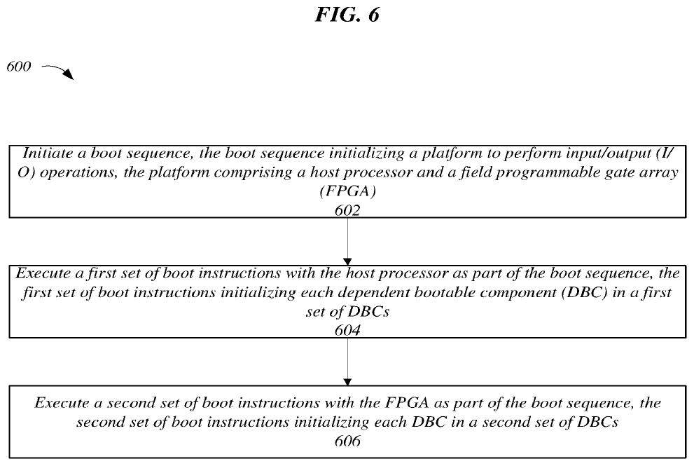

FIG. 6 illustrates one embodiment of a logic flow 600, which may be representative of operations that may be executed in various embodiments in conjunctions with platform initialization. The logic flow 600 may be representative of some or all of the operations that may be executed by one or more components of operating environments 100, 200, or 300 of FIGS. 1-3, such as host processor 104, FPGA 106, BDCs 108, and/or logic 110. The embodiments are not limited in this context.

In the illustrated embodiment shown in FIG. 6, the logic flow 600 may begin at block 602. At block 602 “initiate a boot sequence, the boot sequence initializing a platform to perform input/output (I/O) operations, the platform comprising a host processor and a field programmable gate array (FPGA)” a boot sequence to initialize a platform including a host processor and an FPGA to perform I/O operation. For example, a boot sequence to initialize computing platform 102 may be initiated. In various embodiments, the boot sequence may be initiated in response to the computing platform 102 being powered on. In some embodiments, host processor 104 may initiate the boot sequence.

Continuing to block 604 “execute a first set of boot instructions with the host processor as part of the boot sequence, the first set of boot instructions initializing each dependent bootable component (DBC) in a first set of DBCs” a first set of boot instructions may be executed with the host processor as part of the boot sequence, wherein the first set of boot instructions initialize each DBS in a first set of DBCs. For example, host processor 104 may execute host boot instructions 204 to initialize one or more of DBCs 108. In some embodiments, host processor 104 may initialize one or more of silicon components 208. In various embodiments, host processor 104 may initialize one or more of platform components 210.

Proceeding to block 606 “execute a second set of boot instructions with the FPGA as part of the boot sequence, the second set of boot instructions initializing each DBC in a second set of DBCs” a second set of boot instructions may be executed with the FPGA as part of the boot sequence, wherein the second set of boot instructions initialize each DBS in a second set of DBCs. For example, FPGA 106 may execute host boot instructions 206 to initialize one or more of DBCs 108. In some embodiments, FPGA 106 may initialize one or more of silicon components 208. In various embodiments, FPGA 106 may initialize one or more of platform components 210.

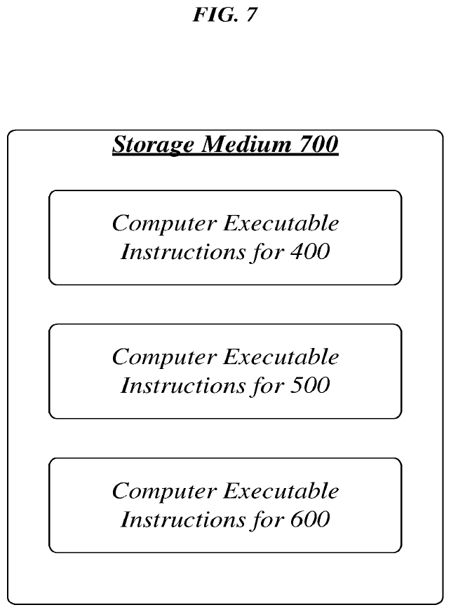

FIG. 7 illustrates an embodiment of a storage medium 700. Storage medium 700 may comprise any non-transitory computer-readable storage medium or machine-readable storage medium, such as an optical, magnetic or semiconductor storage medium. In various embodiments, storage medium 700 may comprise an article of manufacture. In some embodiments, storage medium 700 may store computer-executable instructions, such as computer-executable instructions to implement one or more of logic flows or operations described herein, such as with respect to logic flow 400 of FIG. 4, logic flow 500 of FIG. 5, and logic flow 600 of FIG. 6. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

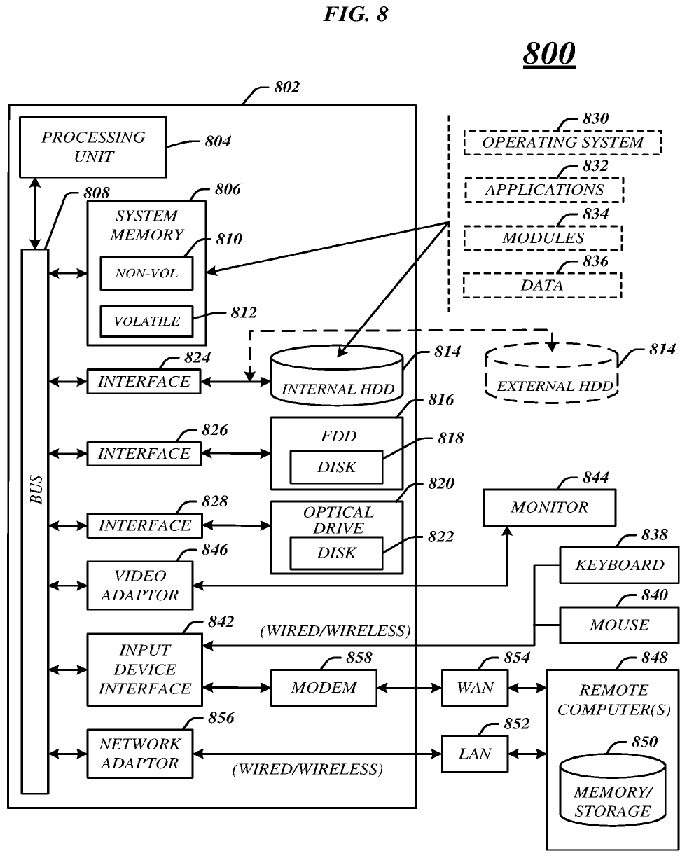

FIG. 8 illustrates an embodiment of an exemplary computing architecture 800 that may be suitable for implementing various embodiments as previously described. In various embodiments, the computing architecture 800 may comprise or be implemented as part of an electronic device. In some embodiments, the computing architecture 800 may be representative, for example, of a computer system that implements or utilizes one or more components of operating environment 100 of FIG. 1, operating environment 200 of FIG. 2, and/or operating environment 300 of FIG. 3. In some embodiments, computing architecture 800 may be representative, for example, of one or more portions of computing platform 102 that implement or utilize one or more embodiments described herein. For instance, host processor 104 may be a central processing unit (CPU) operating in conjunction with computing architecture 800. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. In some embodiments, system memory 806 may include main memory. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and Institute of Electrical and Electronics Engineers (IEEE) 994 interface technologies. In various embodiments, these types of memory may not be included in main memory or system memory.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of computing platform 102, such as logic 110.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 994 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. In various embodiments, one or more migrations may occur via the networked environment. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 1358, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

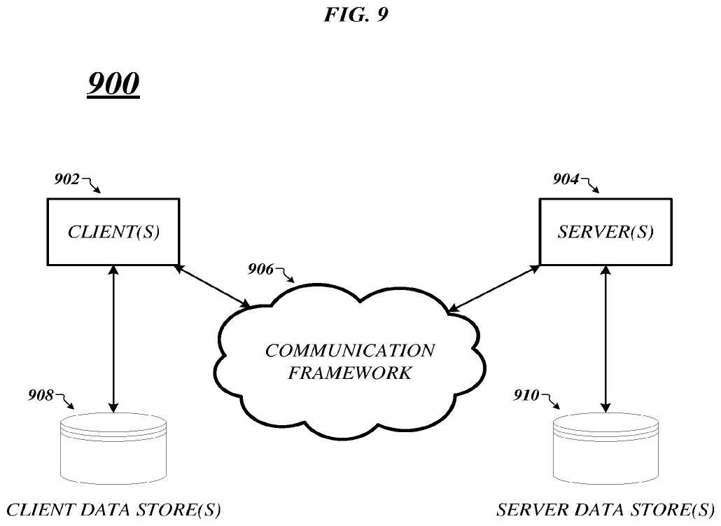

FIG. 9 illustrates a block diagram of an exemplary communications architecture 900 suitable for implementing various embodiments as previously described, such as virtual machine migration. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 and the servers 904 are operatively connected to one or more respective client data stores 908 and server data stores 910 that can be employed to store information local to the respective clients 902 and servers 904, such as cookies and/or associated contextual information. In various embodiments, any one of servers 904 may implement one or more of logic flows or operations described herein, and storage medium 700 of FIG. 7 in conjunction with storage of data received from any one of clients 902 on any of server data stores 910. In one or more embodiments, one or more of client data store(s) 908 or server data store(s) 910 may include memory accessible to host processor 104 and/or FPGA 106.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus for platform initialization, the apparatus comprising: a memory; and logic, at least a portion of the logic implemented in circuitry coupled to the memory, the logic to: initiate a boot sequence, the boot sequence initializing a platform to perform input/output (I/O) operations, the platform comprising a host processor and a field programmable gate array (FPGA); execute a first set of boot instructions with the host processor as part of the boot sequence, the first set of boot instructions initializing each dependent bootable component (DBC) in a first set of DBCs; and execute a second set of boot instructions with the FPGA as part of the boot sequence, the second set of boot instructions initializing each DBC in a second set of DBCs.

Example 2 includes the subject matter of Example 1, wherein initialization of a DBC in the first set of DBCs is dependent on initialization of another DBC in the second set of DBCs.

Example 3 includes the subject matter of Example 1, wherein a first DBC in the first set of DBCs comprises an operating system and a second DBC in the second set of DBCs comprises a firmware interface.

Example 4 includes the subject matter of Example 1, the platform to perform I/O operations via an operating system executed by the host processor.

Example 5 includes the subject matter of Example 1, wherein a first DBC in the first set comprises a power management controller and a second DBC in the second set comprises a bus controller.

Example 6 includes the subject matter of Example 1, a first DBC in the first set comprising a library, wherein initialization of the first DBC includes loading the library from the memory.

Example 7 includes the subject matter of Example 6, a second DBC in the second set comprising a memory controller, wherein initialization of the second DBC occurs before initialization of the first DBC.

Example 8 includes the subject matter of Example 1, a DBC in the first set of DBCs comprising a device tree, wherein initialization of the DBC includes building the device tree.

Example 9 includes the subject matter of Example 1, a DBC in the second set of DBCs comprising a bus design, wherein initialization of the DBC includes loading the bus design.

Example 10 includes the subject matter of Example 1, a DBC in the second set of DBCs comprising a network design, wherein initialization of the second DBC includes loading the network design.

Example 11 includes the subject matter of Example 1, a DBC in the first set comprising a core of the host processor.

Example 12 includes the subject matter of Example 1, a DBC in the second set comprising a soft processor of the FPGA.

Example 13 includes the subject matter of Example 1, the second set of boot instructions located in an FPGA memory.

Example 14 includes the subject matter of Example 1, the FPGA to indicate successful initialization of a DBC in the second set of DBCs to the host processor.

Example 15 includes the subject matter of Example 1, the logic to reconfigure the FPGA to perform a runtime operation after completion of the boot sequence.

Example 16 is a system for platform initialization, the system comprising: a platform comprising a set of dependent boot components (DBCs); a host processor to execute a first set of boot instructions as part of a boot sequence initializing the platform to perform input/output (I/O) operations, the first set of boot instructions initializing each DBC in a first subset of the set of DBCs; and a field programmable gate array (FPGA) to execute a second set of boot instructions as part of the boot sequence, the second set of boot instructions initializing each DBC in a second subset of the set of DBCs.

Example 17 includes the subject matter of Example 16, wherein initialization of a first DBC in the first subset is dependent on initialization of a second DBC in the second subset.

Example 18 includes the subject matter of Example 16, wherein a first DBC in the first subset comprises an operating system and a second DBC in the second subset comprises a firmware interface.

Example 19 includes the subject matter of Example 16, the platform to perform I/O operations via an operating system executed by the host processor.

Example 20 includes the subject matter of Example 16, wherein a first DBC in the first set comprises a power management controller and a second DBC in the second set comprises a bus controller.

Example 21 includes the subject matter of Example 16, a first DBC in the first set comprising a library, wherein initialization of the first DBC includes loading the library from a memory.

Example 22 includes the subject matter of Example 21, a second DBC in the second set comprising a memory controller, wherein initialization of the second DBC occurs before initialization of the first DBC.

Example 23 includes the subject matter of Example 16, a DBC in the first subset comprising a device tree, wherein initialization of the DBC includes building the device tree.

Example 24 includes the subject matter of Example 16, a DBC in the second subset comprising a bus design, wherein initialization of the DBC includes loading the bus design.

Example 25 includes the subject matter of Example 16, a DBC in the second subset comprising a network design, wherein initialization of the second DBC includes loading the network design.

Example 26 includes the subject matter of Example 16, a DBC in the first subset comprising a core of the host processor.

Example 27 includes the subject matter of Example 16, a DBC in the second subset comprising a soft processor of the FPGA.

Example 28 includes the subject matter of Example 16, the second set of boot instructions located in an FPGA memory.

Example 29 includes the subject matter of Example 16, the FPGA to indicate successful initialization of a DBC in the second subset to the host processor.

Example 30 includes the subject matter of Example 16, the FPGA to reconfigure to perform a runtime operation after completion of the boot sequence.

Example 31 is at least one non-transitory computer-readable medium comprising a set of instructions that, in response to being executed by a processor circuit, cause the processor circuit to: initiate a boot sequence, the boot sequence initializing a platform to perform input/output (I/O) operations, the platform comprising a host processor and a field programmable gate array (FPGA); execute a first set of boot instructions with the host processor as part of the boot sequence, the first set of boot instructions initializing each dependent bootable component (DBC) in a first set of DBCs; and execute a second set of boot instructions with the FPGA as part of the boot sequence, the second set of boot instructions initializing each DBC in a second set of DBCs.

Example 32 includes the subject matter of Example 31, wherein initialization of a DBC in the first set of DBCs is dependent on initialization of another DBC in the second set of DBCs.

Example 33 includes the subject matter of Example 31, wherein a first DBC in the first set of DBCs comprises an operating system and a second DBC in the second set of DBCs comprises a firmware interface.

Example 34 includes the subject matter of Example 31, the platform to perform I/O operations via an operating system executed by the host processor.

Example 35 includes the subject matter of Example 31, wherein a first DBC in the first set comprises a power management controller and a second DBC in the second set comprises a bus controller.

Example 36 includes the subject matter of Example 31, a first DBC in the first set comprising a library, wherein initialization of the first DBC includes loading the library from a memory.

Example 37 includes the subject matter of Example 36, a second DBC in the second set comprising a memory controller, wherein initialization of the second DBC occurs before initialization of the first DBC.

Example 38 includes the subject matter of Example 31, a DBC in the first set of DBCs comprising a device tree, wherein initialization of the DBC includes building the device tree.

Example 39 includes the subject matter of Example 31, a DBC in the second set of DBCs comprising a bus design, wherein initialization of the DBC includes loading the bus design.

Example 40 includes the subject matter of Example 31, a DBC in the second set of DBCs comprising a network design, wherein initialization of the second DBC includes loading the network design.

Example 41 includes the subject matter of Example 31, a DBC in the first set comprising a core of the host processor.

Example 42 includes the subject matter of Example 31, a DBC in the second set comprising a soft processor of the FPGA.

Example 43 includes the subject matter of Example 31, the second set of boot instructions located in an FPGA memory.

Example 44 includes the subject matter of Example 31, the FPGA to indicate successful initialization of a DBC in the second set of DBCs to the host processor.

Example 45 includes the subject matter of Example 31, comprising instructions that, in response to being executed by the processor circuit, cause the processor circuit to reconfigure the FPGA to perform a runtime operation after completion of the boot sequence.

Examples 46 is a computer-implemented method, comprising: initiating a boot sequence, the boot sequence initializing a platform to perform input/output (I/O) operations, the platform comprising a host processor and a field programmable gate array (FPGA); executing a first set of boot instructions with the host processor as part of the boot sequence, the first set of boot instructions initializing each dependent bootable component (DBC) in a first set of DBCs; and executing a second set of boot instructions with the FPGA as part of the boot sequence, the second set of boot instructions initializing each DBC in a second set of DBCs.

Example 47 includes the subject matter of Example 46, wherein initialization of a DBC in the first set of DBCs is dependent on initialization of another DBC in the second set of DBCs.

Example 48 includes the subject matter of Example 46, wherein a first DBC in the first set of DBCs comprises an operating system and a second DBC in the second set of DBCs comprises a firmware interface.

Example 49 includes the subject matter of Example 46, comprising performing I/O operations via an operating system executed by the host processor.

Example 50 includes the subject matter of Example 46, wherein a first DBC in the first set comprises a power management controller and a second DBC in the second set comprises a bus controller.

Example 51 includes the subject matter of Example 46, a first DBC in the first set comprising a library, wherein initialization of the first DBC includes loading the library from the memory.

Example 52 includes the subject matter of Example 51, a second DBC in the second set comprising a memory controller, wherein initialization of the second DBC occurs before initialization of the first DBC.

Example 53 includes the subject matter of Example 46, a DBC in the first set of DBCs comprising a device tree, wherein initialization of the DBC includes building the device tree.

Example 54 includes the subject matter of Example 46, a DBC in the second set of DBCs comprising a bus design, wherein initialization of the DBC includes loading the bus design.

Example 55 includes the subject matter of Example 46, a DBC in the second set of DBCs comprising a network design, wherein initialization of the second DBC includes loading the network design.

Example 56 includes the subject matter of Example 46, a DBC in the first set comprising a core of the host processor.

Example 57 includes the subject matter of Example 46, a DBC in the second set comprising a soft processor of the FPGA.

Example 58 includes the subject matter of Example 46, the second set of boot instructions located in an FPGA memory.

Example 59 includes the subject matter of Example 46, comprising indicating successful initialization of a DBC in the second set of DBCs to the host processor.

Example 60 includes the subject matter of Example 46, comprising reconfiguring the FPGA to perform a runtime operation after completion of the boot sequence.

Example 61 is an apparatus, comprising: means for initiating a boot sequence, the boot sequence initializing a platform to perform input/output (I/O) operations, the platform comprising a host processor and a field programmable gate array (FPGA); means for executing a first set of boot instructions with the host processor as part of the boot sequence, the first set of boot instructions initializing each dependent bootable component (DBC) in a first set of DBCs; and means for executing a second set of boot instructions with the FPGA as part of the boot sequence, the second set of boot instructions initializing each DBC in a second set of DBCs.

Example 62 includes the subject matter of Example 61, wherein initialization of a DBC in the first set of DBCs is dependent on initialization of another DBC in the second set of DBCs.

Example 63 includes the subject matter of Example 61, wherein a first DBC in the first set of DBCs comprises an operating system and a second DBC in the second set of DBCs comprises a firmware interface.

Example 64 includes the subject matter of Example 61, comprising means for performing I/O operations via an operating system executed by the host processor.

Example 65 includes the subject matter of Example 61, wherein a first DBC in the first set comprises a power management controller and a second DBC in the second set comprises a bus controller.

Example 66 includes the subject matter of Example 61, a first DBC in the first set comprising a library, wherein initialization of the first DBC includes loading the library from the memory.

Example 67 includes the subject matter of Example 66, a second DBC in the second set comprising a memory controller, wherein initialization of the second DBC occurs before initialization of the first DBC.

Example 68 includes the subject matter of Example 61, a DBC in the first set of DBCs comprising a device tree, wherein initialization of the DBC includes building the device tree.

Example 69 includes the subject matter of Example 61, a DBC in the second set of DBCs comprising a bus design, wherein initialization of the DBC includes loading the bus design.

Example 70 includes the subject matter of Example 61, a DBC in the second set of DBCs comprising a network design, wherein initialization of the second DBC includes loading the network design.

Example 71 includes the subject matter of Example 61, a DBC in the first set comprising a core of the host processor.

Example 72 includes the subject matter of Example 61, a DBC in the second set comprising a soft processor of the FPGA.

Example 73 includes the subject matter of Example 61, the second set of boot instructions located in an FPGA memory.

Example 74 includes the subject matter of Example 61, comprising means for indicating successful initialization of a DBC in the second set of DBCs to the host processor.

Example 75 includes the subject matter of Example 61, comprising means for reconfiguring the FPGA to perform a runtime operation after completion of the boot sequence.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1.-25. (canceled)

26. An apparatus for platform initialization, the apparatus comprising:
a memory; and
logic, at least a portion of the logic implemented in circuitry coupled to the memory, the logic to:
initiate a boot sequence, the boot sequence initializing a platform to perform input/output (I/O) operations, the platform comprising a host processor and a field programmable gate array (FPGA);
execute a first set of boot instructions with the host processor as part of the boot sequence, the first set of boot instructions initializing each dependent bootable component (DBC) in a first set of DBCs; and
execute a second set of boot instructions with the FPGA as part of the boot sequence, the second set of boot instructions initializing each DBC in a second set of DBCs.

27. The apparatus of claim 26, wherein initialization of a DBC in the first set of DBCs is dependent on initialization of another DBC in the second set of DBCs.

28. The apparatus of claim 26, wherein a first DBC in the first set of DBCs comprises an operating system and a second DBC in the second set of DBCs comprises a firmware interface.

29. The apparatus of claim 26, the platform to perform I/O operations via an operating system executed by the host processor.

30. The apparatus of claim 26, wherein a first DBC in the first set comprises a power management controller and a second DBC in the second set comprises a bus controller.

31. The apparatus of claim 26, a first DBC in the first set comprising a library, wherein initialization of the first DBC includes loading the library from the memory.

32. The apparatus of claim 31, a second DBC in the second set comprising a memory controller, wherein initialization of the second DBC occurs before initialization of the first DBC.

33. The apparatus of claim 26, a DBC in the first set of DBCs comprising a device tree, wherein initialization of the DBC includes building the device tree.

34. The apparatus of claim 26, a DBC in the second set of DBCs comprising a bus design, wherein initialization of the DBC includes loading the bus design.

35. The apparatus of claim 26, a DBC in the second set of DBCs comprising a network design, wherein initialization of the second DBC includes loading the network design.

36. The apparatus of claim 26, a DBC in the first set comprising a core of the host processor.

37. The apparatus of claim 26, a DBC in the second set comprising a soft processor of the FPGA.

38. The apparatus of claim 26, the second set of boot instructions located in an FPGA memory.

39. The apparatus of claim 26, the FPGA to indicate successful initialization of a DBC in the second set of DBCs to the host processor.

40. The apparatus of claim 26, the logic to reconfigure the FPGA to perform a runtime operation after completion of the boot sequence.

41. A system for platform initialization, the system comprising:
a platform comprising a set of dependent boot components (DBCs);
a host processor to execute a first set of boot instructions as part of a boot sequence initializing the platform to perform input/output (I/O) operations, the first set of boot instructions initializing each DBC in a first subset of the set of DBCs; and
a field programmable gate array (FPGA) to execute a second set of boot instructions as part of the boot sequence, the second set of boot instructions initializing each DBC in a second subset of the set of DBCs.

42. The system of claim 41, wherein initialization of a first DBC in the first subset is dependent on initialization of a second DBC in the second subset.

43. The system of claim 41, wherein a first DBC in the first subset comprises an operating system and a second DBC in the second subset comprises a firmware interface.

44. The system of claim 41, the platform to perform I/O operations via an operating system executed by the host processor.

45. The system of claim 41, wherein a first DBC in the first set comprises a power management controller and a second DBC in the second set comprises a bus controller.

46. A computer-implemented method, comprising:
initiating a boot sequence, the boot sequence initializing a platform to perform input/output (I/O) operations, the platform comprising a host processor and a field programmable gate array (FPGA);
executing a first set of boot instructions with the host processor as part of the boot sequence, the first set of boot instructions initializing each dependent bootable component (DBC) in a first set of DBCs; and
executing a second set of boot instructions with the FPGA as part of the boot sequence, the second set of boot instructions initializing each DBC in a second set of DBCs.

47. The computer-implemented method of claim 46, wherein initialization of a DBC in the first set of DBCs is dependent on initialization of another DBC in the second set of DBCs.

48. The computer-implemented method of claim 46, wherein a first DBC in the first set of DBCs comprises an operating system and a second DBC in the second set of DBCs comprises a firmware interface.

49. The computer-implemented method of claim 46, comprising performing I/O operations via an operating system executed by the host processor.

50. The computer-implemented method of claim 46, wherein a first DBC in the first set comprises a power management controller and a second DBC in the second set comprises a bus controller.
